(19) United States
(12) Patent Application Publication
(10) Pub. No.: US 2019/0118406 A1
(43) Pub. Date: Apr. 25, 2019

(54) EMERGENCY STOP DEVICE OF A WOOD PLANING MACHINE

(71) Applicant: Bor-Yann CHUANG, Taichung City (TW)

(72) Inventor: Bor-Yann CHUANG, Taichung City (TW)

(21) Appl. No.: 15/789,374

(22) Filed: Oct. 20, 2017

(51) Int. Cl. B27G 21/00; B27C 1/14

(52) U.S. Cl. CPC B27G 21/00; B27C 1/14

(57) ABSTRACT

An emergency stop device of a wood planing machine is fixed with a wood planing machine. The emergency stop device includes an elongated touch board, two push buttons and two elastic members. The elongated touch board covers the push buttons and the elastic members, and the push buttons are electrically connected with a power supply unit, while the elastic members have their elastic ends pressing against the elongated touch board. Thus, in normal state, the elastic members will press against the elongated touch board and in emergency, the elongated touch board can be pressed to compress the elastic members and further press the push buttons to stop the power supply unit and make the wood planing machine stop operating.

### BACKGROUND OF THE INVENTION

### 1. Field of the Invention

This invention relates to an emergency stop device, particularly to an emergency stop device of a wood planing machine.

### 2. Description of the Prior Art

Generally, a conventional wood planing machine includes a fundamental base provided thereon with a working table and an emergency cut-off button, and a user is to stand for carrying out wood planing operation on the working table. When an emergency occurs in the operating process of the wood planing machine, the user can press the emergency cut-off button to make the wood planing machine stop operating.

However, the conventional emergency cut-off button is a small-sized button and only provided at somewhere of the fundamental base; therefore, when an emergency occurs, if a user is standing at the opposite side of the emergency cut-off button, he will be unable to cut off the power source of the wood planing machine immediately, or when a user is operating the wood planing machine, he can hardly free up his hands to press the emergency cut-off button and thus, operation of the wood planing machine will be out of control and an accident may occur. Therefore, having observed the above-mentioned drawbacks, the inventor of this invention thinks that the emergency stop device of the conventional wood planing machine is necessary to be ameliorated and hence devises this invention.

### SUMMARY OF THE INVENTION

The objective of this invention is to offer an emergency stop device of a wood planing machine, which can quickly and conveniently stop the wood planing machine from operating for lowering danger of the wood planing machine when an emergency occurs.

The emergency stop device of a wood planing machine in the present invention is fixed with a wood planing machine, which is provided with a frame body, a working table and a power supply unit. This invention is characterized by an emergency stop device containing an elongated touch board, at least two push buttons and at least two elastic members. The elongated touch board is disposed on the frame body and covers the push buttons and the elastic members. The push buttons are respectively secured with the frame body and electrically connected with the power supply unit. The electric members have their elastic ends pressing against the elongated touch board.

In normal state, the elastic members of the emergency stop device of a wood planning machine of this invention will press against the elongated touch board and in emergency, the elongated touch board can be pressed to compress the elastic members and then press the push buttons for stopping the power supply unit and making the wood planing machine stop operating.

### BRIEF DESCRIPTION OF DRAWINGS

This invention will be better understood by referring to the accompanying drawings, wherein:

FIG. 1 is a perspective diagram of a preferred embodiment of an emergency stop device of a wood planing machine in the present invention;

FIG. 2 is an exploded perspective diagram of the preferred embodiment of the emergency stop device of a wood planing machine in the present invention;

FIG. 3 is a partial exploded perspective diagram of the preferred embodiment of the emergency stop device of a wood planing machine in the present invention;

FIG. 4 is a partial cross-sectional diagram of the preferred embodiment of the emergency stop device of a wood planing machine in the present invention;

FIG. 5 is a schematic diagram of the preferred embodiment of the emergency stop device of a wood planing machine in a using condition in normal state in the present invention; and

FIG. 6 is a schematic diagram of the preferred embodiment of the emergency stop device of a wood planing machine in a using condition in emergency in the present invention.

### DETAILED DESCRIPTION OF THE PREFERRED EMBODIMENT

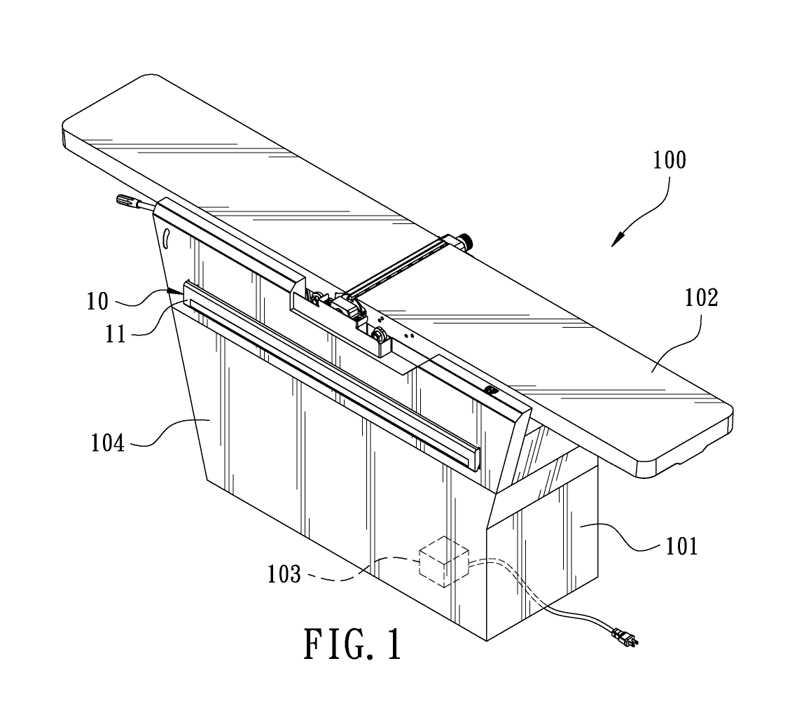

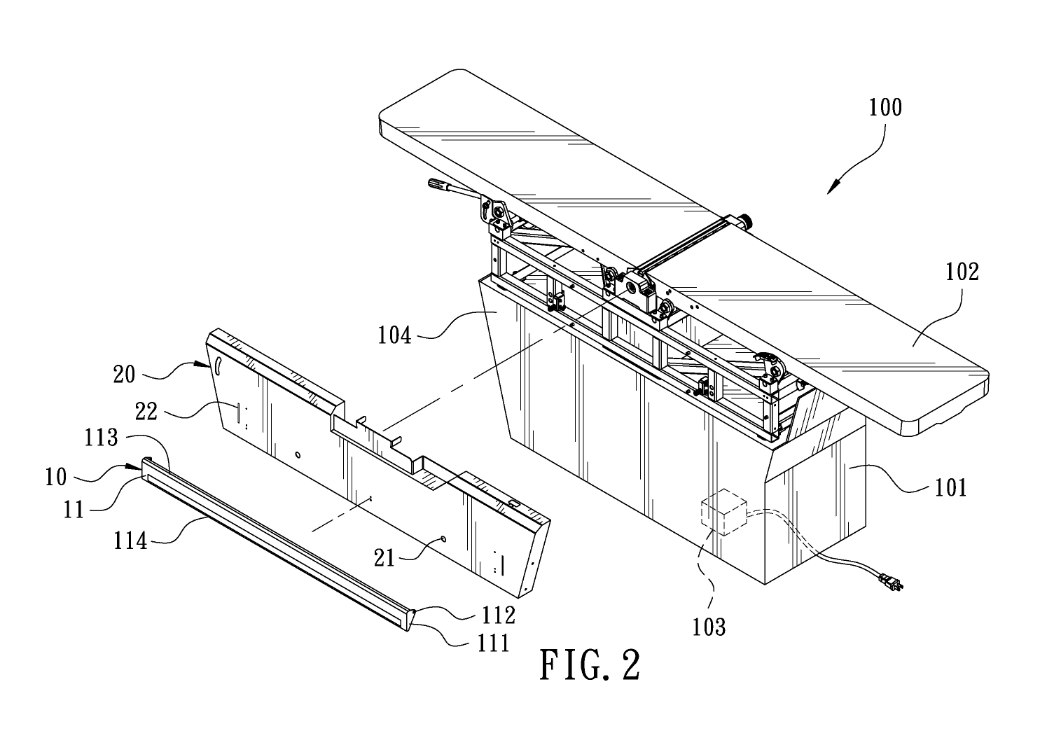

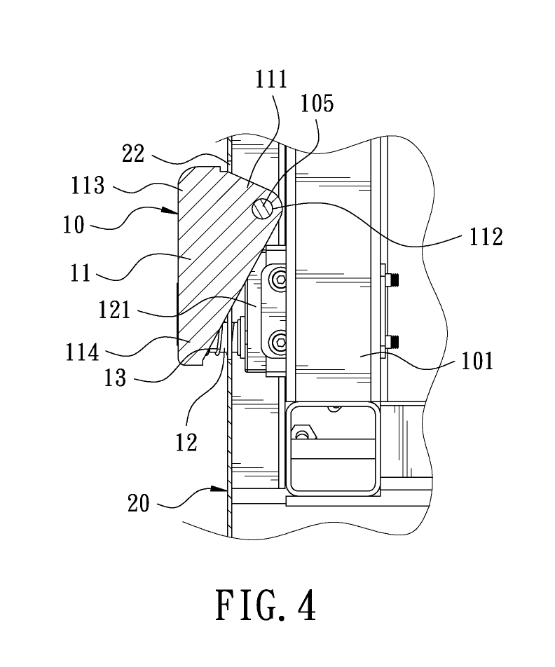

A preferred embodiment of an emergency stop device of a wood planing machine in the present invention, as shown in FIGS. 1, 2 and 4, is fixed with a wood planing machine 100, which includes a frame body 101, a working table 102 and a power supply unit 103. The working table 102 is formed with a major axis and the frame body 101 is provided with a long lateral side 104 corresponding to the major axis.

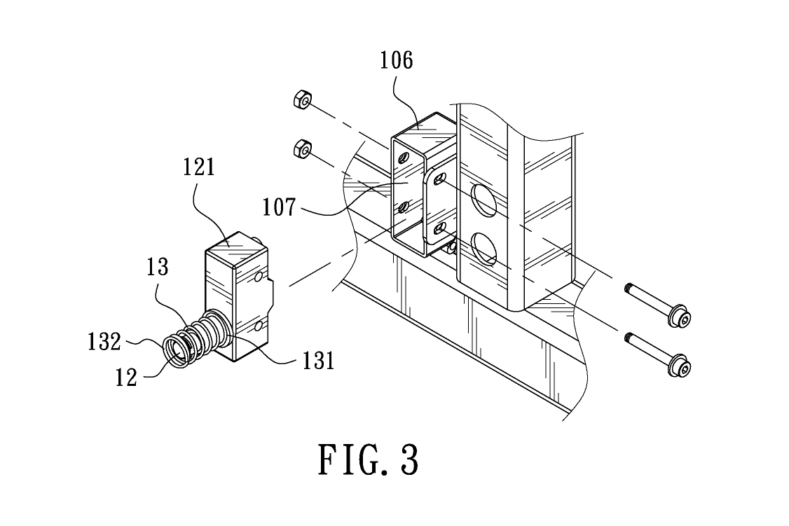

The emergency stop device 10 is provided at the long lateral side 104 of frame body 101, consisting of an elongated touch board 11, at least two push buttons 12 and at least two elastic members 13. The elongated touch board 11 is set at the long lateral side 104 along the direction of the major axis, and the length of the elongated touch board 11 is 80% larger than the length of the long lateral side 104. Further, the elongated touch board 11 has two sides respectively extending toward the frame body 101 and forming a fixing portion 111, which is board with a pivotal hole 112. Pivots 105 are respectively inserted though the pivotal holes 112 to fix the elongated touch board 11 on the frame body 101, letting the elongated touch board 11 pivotally fixed at the long lateral side 104 of the frame body 101 and cover both the push buttons 12 and the elastic members 13 and having the push buttons 12 and the elastic members 13 positioned between the elongated touch board 11 and the frame body 101. The elongated touch board 11 is formed with a first side 113 and a second side 114 along two ends of its minor axis. The first side 113 faces the working table 102, and the push buttons 12 are provided at a relative position corresponding with the second side 114 of the elongated touch board 11. Referring to FIG. 3, the frame body 101 is provided with an accommodating seat 106 corresponding to the push buttons 12, and the accommodating seat 106 contains an accommodating chamber 107 for receiving the push buttons 12 therein via a mounting member 121. The push buttons 12 are electrically connected with the power supply unit 103, and the elastic members 13 are respectively fitted around the push buttons 12. The fixed ends of the elastic members 13 are secured with the mounting member 121, while the elastic ends 132 of the elastic members 13 push against the elongated touch board 11. In this preferred embodiment, the elastic members 13 are springs.

A casing 20 disposed between the frame body 101 and the elongated touch board 11 is bored with openings 21 at locations respectively corresponding to the push buttons 12 for the push buttons 12 to be inserted therethrough, and provided with slits 22 at locations respectively corresponding to the fixing portions 111 of the elongated touch board 11 for the fixing portions 111 to be inserted therethrough and fixed with the frame body 101.

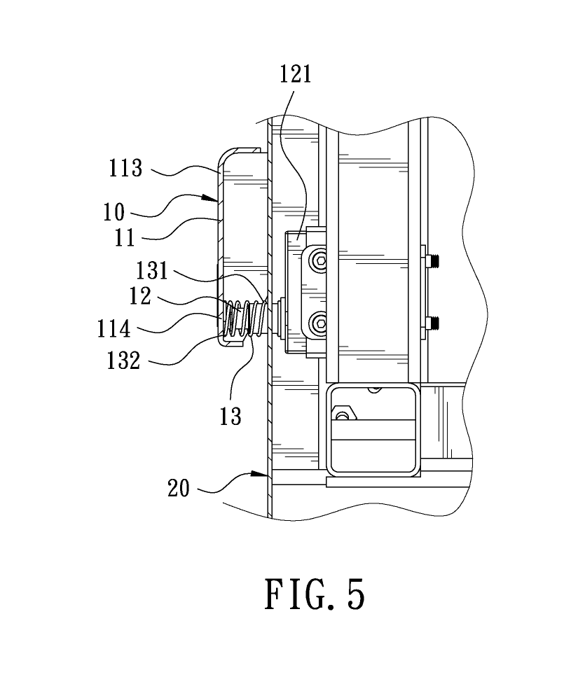

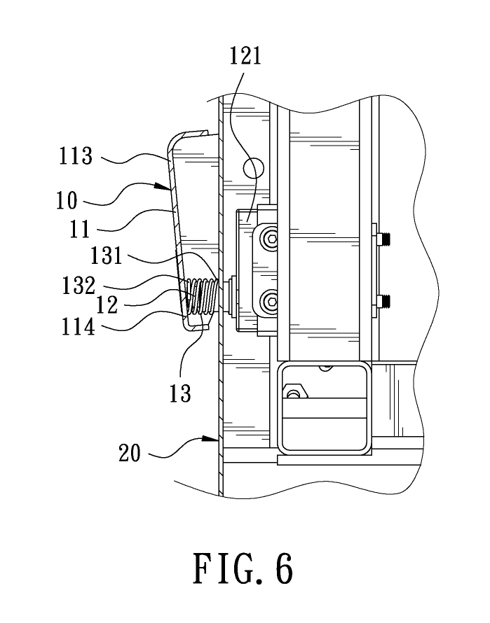

Referring to FIG. 5, when the wood planing machine is used in a normal state, a user is to stand for carrying out wood planing operation on the working table 102 and at this time, the elastic ends 132 of the elastic members 13 will elastically press against the elongated touch board 11, rendering the elongated touch board 11 and the push buttons 12 separated from each other and enabling the wood planning machine 100 to operate continuously. Referring to FIG. 6, when an emergency occurs, the user can press the elongated touch board 11 to make the elongated touch board 11 compress the elastic members 13 and then press the push buttons 12 to stop the power supply unit 103 and make the wood planing machine 100 stop operating, thus lowering danger when an emergency occurs.

What is worth mentioning is that the elongated touch board 11 is provided at the long lateral side 104 along the major axis, and the elongated touch board 11 is 80% longer than the long lateral side 104 and further, the elongated touch board 11 is approximately provided at the location of a user's knee. Therefore, when a user's hands are busy operating the wood planing machine 100 on the working table 102 and if an emergency occurs, the user can directly employ his knee to urgently press the elongated touch board 11 to push the push buttons 12 for stopping the wood planing machine 100 from operating. Thus, a user does not need to move his position and his hands still can continuously operate the wood planing machine 100. Compared with the conventional way of using a user's hands to press the emergency cut-off button, this invention can urgently make the wood planing machine 100 stop operating more quickly and conveniently.

While the preferred embodiment of the invention has been described above, it will be recognized and understood that various modifications may be made therein and the appended claims are intended to cover all such modifications that may fall within the spirit and scope of this invention.

What is claimed is:

1. An emergency stop device of a wood planing machine secured with a wood planing machine, said wood planing machine comprising a frame body, a working table and a power supply unit, and characterized by,
an emergency stop device comprising an elongated touch board, at least two push buttons and at least two elastic members, said elongated touch board fixed with said frame body, said elongated touch board covering said push buttons and said elastic members, said push buttons respectively set on said frame body, said push buttons electrically connected said power supply unit, said elastic members having their elastic ends pressing against said elongated touch board;
Thus, in normal state, said elastic members pressing against said elongated touch board, in emergency, said elongated touch board able to be pressed to compress said elastic members and then press said push buttons to stop said power supply unit and make said wood planing machine stop operating.

2. The emergency stop device of a wood planing machine as claimed in claim 1, wherein said working table is formed with a major axis, said frame body provided with a long lateral side corresponding with the major axis, said long lateral side provided thereon with said elongated touch board.

3. The emergency stop device of a wood planing machine as claimed in claim 2, wherein said elongated touch board is 80% longer than said long lateral side.

4. The emergency stop device of a wood planing machine as claimed in claim 1, wherein said elongated touch board is formed with a first side and a second side at two ends of a minor axis, said first side facing said working table, said push buttons installed on said frame body at a relative position corresponding to said second side of said elongated touch board.

5. The emergency stop device of a wood planing machine as claimed in claim 1, wherein said frame body is disposed with a casing, said casing positioned between said frame body and said elongated touch board, said casing bored with openings respectively corresponding with said push buttons for said push buttons to be inserted therethrough.

6. The emergency stop device of a wood planing machine as claimed in claim 5, wherein said elongated touch board has two sides respectively extending toward said frame body to form a fixing portion, said casing provided with slits respectively corresponding to said fixing portions for said fixing portion to be inserted through said slits and secured on said frame body.

7. The emergency stop device of a wood planing machine as claimed in claim 6, wherein said fixing portions are respectively bored with a pivotal hole, a pivot inserted through said pivotal hole to fix said elongated touch board on said frame body.

8. The emergency stop device of a wood planing machine as claimed in claim 1, wherein said frame body is provided with an accommodating seat, said accommodating seat comprising an accommodating chamber.

9. The emergency stop device of a wood planing machine as claimed in claim 8, wherein said push buttons are respectively received in said accommodating chamber by means of a mounting member.

10. The emergency stop device of a wood planing machine as claimed in claim 9, wherein said elastic members have their fixed ends secured with said mounting member, said elastic members having their elastic ends pressing against said elongated touch board.

11. The emergency stop device of a wood planing machine as claimed in claim 1, wherein said elastic members are springs.
